(19) United States
(12) Patent Application Publication
(10) Pub. No.: US 2013/0321449 A1
(43) Pub. Date: Dec. 5, 2013

(54) WINDOW COMBINING DEVICE

(71) Applicants: Takafumi Kasuga, Tokyo (JP); Takaaki Kase, Tokyo (JP); Yoshiyuki Kato, Tokyo (JP); Kiyotaka Kato, Tokyo (JP); Akira Torii, Tokyo (JP); Masaki Hamada, Tokyo (JP); Eisuke Yonezawa, Tokyo (JP)

(72) Inventors: Takafumi Kasuga, Tokyo (JP); Takaaki Kase, Tokyo (JP); Yoshiyuki Kato, Tokyo (JP); Kiyotaka Kato, Tokyo (JP); Akira Torii, Tokyo (JP); Masaki Hamada, Tokyo (JP); Eisuke Yonezawa, Tokyo (JP)

(73) Assignee: Mitsubishi Electric Corporation, Tokyo (JP)

(21) Appl. No.: 13/984,996

(22) PCT Filed: Jun. 10, 2011
(86) PCT No.: PCT/JP2011/003313

§ 371 Date: Aug. 12, 2013

(51) Int. Cl. G06T 5/50

(52) U.S. Cl. CPC G06T 5/50
USPC 345/611

(57) ABSTRACT

A window combining device includes a window control unit for adding one window number to pixels on a window-by-window basis, a two-dimensional drawing engine for combining a drawn window including the pixels to which the window number is added by the window control unit into a display window, and a display control unit for displaying the display window into which the drawn window is combined by the two-dimensional drawing engine. When an update occurs in one of a plurality of drawn windows which construct the display window, the two-dimensional drawing engine computes an original background color from a pixel to which a blend flag showing that the pixel is a target for an antialiasing process is added, the pixel being included in pixels of the window for which the update occurs, and carries out the antialiasing process and recombines pixels into the display window.

### FIELD OF THE INVENTION

The present invention relates to a window combining device that combines a plurality of windows to draw these windows.

### BACKGROUND OF THE INVENTION

In graphics drawing, a window is created by drawing a graphic, a font or the like in an area such as a rectangular area. A technology of generating a display window by combining a plurality of drawn windows each of which is created in this way is known. According to this technology, because when an update occurs in either one of the plurality of drawn windows necessary for the creation of a display window, a display window can be created by redrawing only the window in which the update occurs, high-speed drawing can be carried out.

In graphics drawing, in order to grasp a masking process of masking an object such as a graphic to be drawn or a font to be drawn, or a relationship between the depths of windows, a stencil buffer is used. The stencil buffer makes an area which does not have to be drawn because of an overlap between objects controllable on a per pixel basis in graphics drawing. When an update occurs in either one of a plurality of drawn windows necessary for the creation of a display window, the use of this stencil buffer makes it possible to create a display window by redrawing only the window in which the update occurs and combine only this redrawn window into the display window. Therefore, the drawing can be carried out at a higher speed than that at the time of using the above-mentioned method.

Patent reference 1 discloses a window combining device that can speed up drawing by using some planes called graphics control planes in addition to a stencil buffer as a related technology.

### RELATED ART DOCUMENT

### Patent Reference

Patent reference 1: Japanese Patent No. 3413201

### SUMMARY OF THE INVENTION

### Problems to be Solved by the Invention

By the way, in graphics drawing, in order to express the outline of an object smoothly, an antialiasing process may be carried out. In digital graphics, because the outline of an object cannot be drawn in units of an element smaller than each pixel, aliasing called jaggies occurs in the outline of the object. The antialiasing process is the one of dividing each pixel into subpixels to compute a coverage (the percentage of the object that covers the pixel), and drawing, as a drawing color, a color which is acquired by blending the background color and the object color according to the coverage.

In the conventional window combining device shown in patent reference 1, when an update occurs in either one of a plurality of drawn windows necessary for the creation of a display window and the updated window is combined into the display window, only a window with a smaller depth is drawn in an area included in an object of the updated window and overlapping with another window. Therefore, the background color is not drawn. A problem is therefore that the antialiasing process cannot be applied and a high quality display window cannot be created at a high speed.

The present invention is made in order to solve the above-mentioned problem, and it is therefore an object of the present invention to provide a window combining device that can create a high quality display window at a high speed.

### Means for Solving the Problem

In accordance with the present invention, there is provided a window combining device including: a window control unit for adding one window number to pixels on a window-by-window basis; a two-dimensional drawing engine for combining a drawn window including the pixels to which the window number is added by the window control unit into a display window; and a display control unit for displaying the display window into which the drawn window is combined by the two-dimensional drawing engine.

### Advantages of the Invention

The window combining device in accordance with the present invention can create a high quality display window at a high speed.

### BRIEF DESCRIPTION OF THE FIGURES

FIG. 1 is a block diagram showing the structure of an image compositing device including a window combining device in accordance with Embodiment 1 of the present invention;

FIG. 2 is a diagram for explaining drawing of a window which is carried out by the window combining device in accordance with Embodiment 1 of the present invention;

FIG. 3 is a diagram for explaining combining of a window into a display window which is carried out by the window combining device in accordance with Embodiment 1 of the present invention;

FIG. 4 is a flow chart showing a combining process of combining a window into a display window which is carried out by the window combining device in accordance with Embodiment 1 of the present invention;

FIG. 5 is a diagram for explaining recombining of a window into a display window which is carried out by the window combining device in accordance with Embodiment 1 of the present invention;

FIG. 6 is a flow chart showing a recombining process of recombining a window into a display window which is carried out by the window combining device in accordance with Embodiment 1 of the present invention; and

FIG. 7 is a diagram for explaining the configuration of a pixel value for use in the window combining device in accordance with Embodiment 1 of the present invention.

### EMBODIMENTS OF THE INVENTION

Hereafter, in order to explain this invention in greater detail, the preferred embodiments of the present invention will be described with reference to the accompanying drawings.

### Embodiment 1

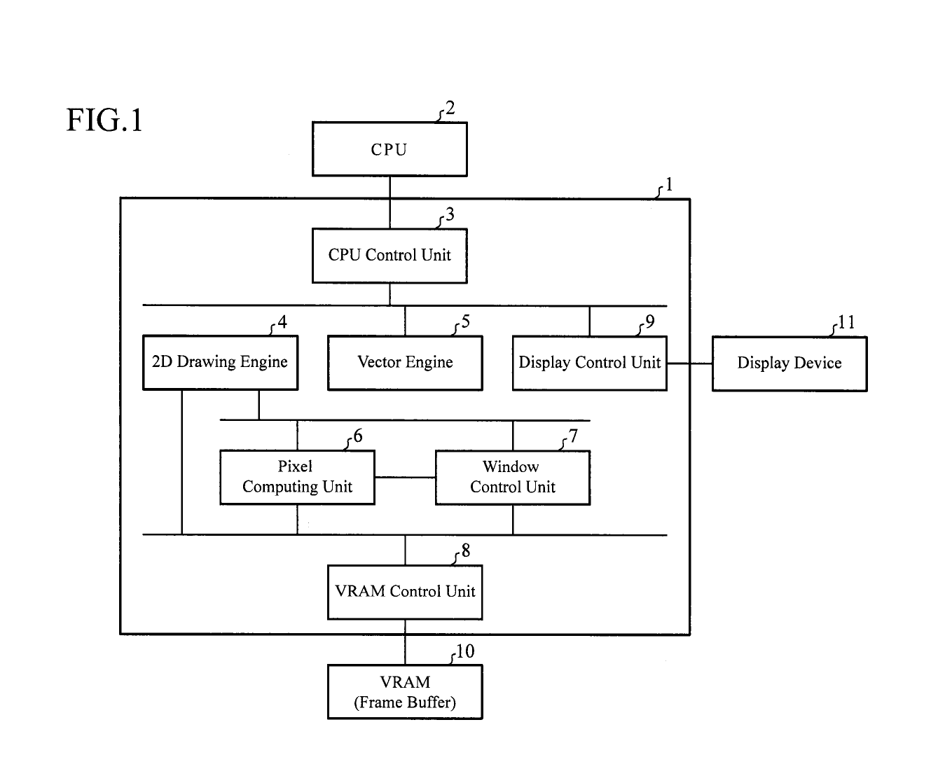

FIG. 1 is a block diagram showing the structure of an image compositing device including a window combining device in accordance with Embodiment 1 of the present invention. This image compositing device includes the window combining device 1, a CPU (Central Processing Unit) 2, a VRAM (Video Random Access Memory) 10, and a display device 11.

The window combining device 1 combines a plurality of windows and draws these windows. The details of this window combining device 1 will be mentioned below. The CPU 2 consists of, for example, a general-purpose microcomputer, and performs a process, such as a process of setting drawing information to the window combining device 1, and controls the entire window combining device 1.

The VRAM 10 is a frame buffer for storing intermediate results of drawing, draw results, etc. which are sent thereto from the window combining device 1. The display device 11 produces a display according to display data sent thereto from the window combining device 1.

Next, the details of the window combining device 1 will be explained. The window combining device 1 includes a CPU control unit 3, a two-dimensional (2D) drawing engine 4, a vector engine 5, a pixel computing unit 6, a window control unit 7, a VRAM control unit 8, and a display control unit 9.

The CPU control unit 3 decodes a command sent thereto from the CPU 2, and sets various pieces of information required to carry out a window combining process which is the target of the command to the two-dimensional drawing engine 4, the vector engine 5, the pixel computing unit 6, the window control unit 7, the VRAM control unit 8, and the display control unit 9 to control these components.

The two-dimensional drawing engine 4 carries out 2D-graphics drawing, such as BitBLT (bit block transfer) or Fill, according to control by the CPU control unit 3. The vector engine 5 converts an image into the coordinates of points, parameters of equations of lines or surfaces each connecting between points, and bit map data which are expressed as an array of pixels to each of which is colored from data expressed as drawing information, such as a color fill or a special effect.

The pixel computing unit 6 carries out pixel arithmetic operations, such as a color key test, an a test, a color transform, an a blend, and dithering, on a pixel. The window control unit 7 controls window numbers.

The VRAM control unit 8 carries out collective management on access to the VRAM 10 by each component of the window combining device 1. The display control unit 9 reads display data from the VRAM 10 by way of the VRAM control unit 8, and sends the display data to the display device 11.

In the image compositing device shown in FIG. 1, the CPU 2, the VRAM 10, and the display device 11 are disposed separately from the window combining device 1. As an alternative, these components can be constructed integrally with the window combining device 1.

The operation of the window combining device 1 constructed as above will be explained. The CPU control unit 3 starts the two-dimensional drawing engine 4 and the vector engine 5 according to a command sent thereto from the CPU 2 to cause the two-dimensional drawing engine 4 and the vector engine 5 to draw a plurality of windows. Drawing data generated through this drawing are stored in the VRAM 10 by way of the VRAM control unit 8. Further, when drawing a window, the window control unit 7 adds one window number to pixels to be drawn on a window-by-window basis.

When creating a display window, the two-dimensional drawing engine 4 reads each drawn window stored in the VRAM 10, and combines only pixels to which a window number is added into the display window. In this case, a blend flag is added to each pixel which is a target for an antialiasing process, the blend flag showing that the pixel is a target for the antialiasing process.

When an update occurs in a drawn window which constructs the display window, the two-dimensional drawing engine 4 reads the updated drawn window from the VRAM 10, and compares the window number added to each pixel of the display window with that added to the corresponding pixel of the drawn window, and updates the pixel value of each pixel only when the window number added to the pixel of the display window matches that added to the corresponding pixel of the drawn window. In this case, only the pixels, among all the pixels of the window for which the update occurs, that appear on the display surface are the target for recombination into the display window. Further, a blend process is carried out on each pixel, among the pixels whose window number match that added to the corresponding pixels of the display window, to which the blend flag is added.

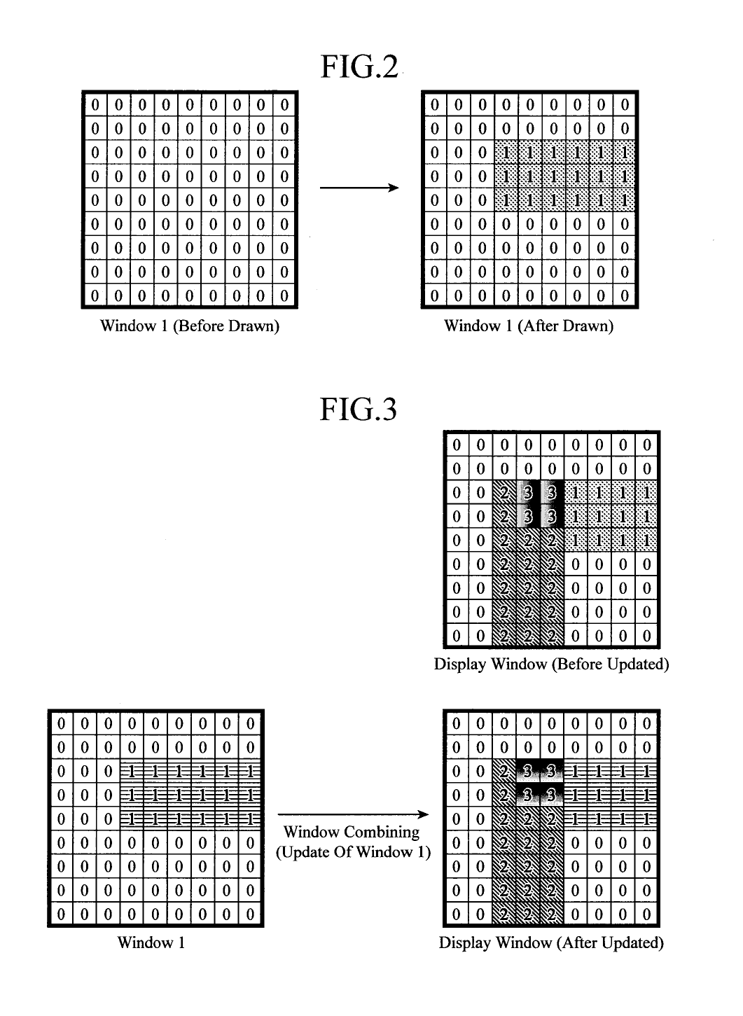

FIG. 2 is a diagram for explaining drawing of a window which is carried out by the window combining device 1. A large rectangle shows the entire window and each minute rectangle shows a pixel. A number in each minute rectangle shows the window number of the pixel. Before the window is drawn, the window number of each of all the pixels is set to “0.” When the window is drawn, only the window number of each pixel which constructs the window to be drawn is updated. In this window combining device 1, an identical window number is added to each window to be drawn. In the example shown in FIG. 2, the window number of the window 1 is set to “1.” Therefore, the window number of each pixel drawn in the window 1 is set to “1.”

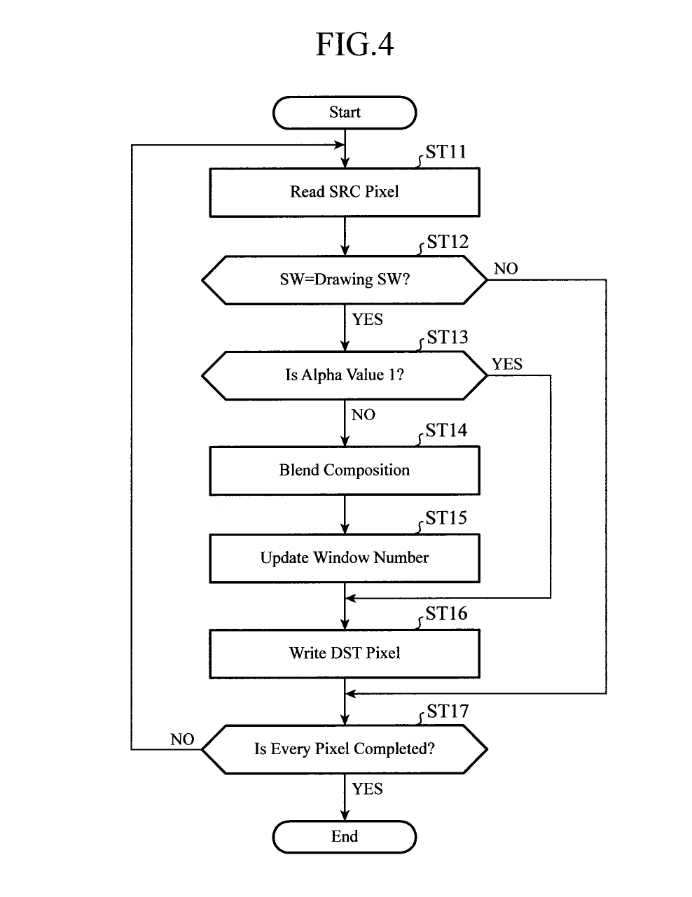

FIG. 3 is a diagram for explaining a process of combining windows into a display window which is carried out by the window combining device 1. FIG. 4 is a flow chart showing the combining process of combining windows into a display window which is carried out by the window combining device 1. In the combining process of combining windows into a display window, a window 1 is first combined into the display window by using BitBLT. The window combining device completes the display window by then combining a window 2 (not shown) into the display window by using BitBLT. In the case of using this BitBLT, the flow chart shown in FIG. 4 is applied to all the pixels.

In the combining process of combining a window into the display window, reading of each SRC pixel is carried out first (step ST11). More specifically, each SRC (source) pixel which is a pixel of a drawn window which is the source of the BitBLT are read from the VRAM (frame buffer) 10.

The window combining device then checks to see whether the window number (drawing SW) of the pixel read in step ST11 matches the window number (SW) currently assigned to the window in the BitBLT (step ST12). When, in this step ST12, determines that the window number of the pixel read in step ST11 does not match that currently assigned to the window in the BitBLT, the window combining device advances the sequence to step ST17 because the window combining device does not have to draw the pixel.

In contrast, when, in step ST12, determining that the window number of the pixel read in step ST11 matches that currently assigned to the window in the BitBLT, the window combining device checks to see whether or not the a value is “1” (step ST13). More specifically, the window combining device checks to see whether or not the a value which is the transparency information of the pixel read in step ST11 is “1.” When, in this step ST13, determining that the a value is “1,” the window combining device advances the sequence to step ST16. More specifically, because it is not necessary to carry out an a blend of a background color and a drawing color when the a value is “1” in the antialiasing process, the window combining device draws the SRC pixel value in the display window as a DST (destination) pixel value, just as it is.

In contrast, when, in step ST13, determining that the a value is not “1,” the window combining device carries out blend composition (step ST14). More specifically, the window combining device carries out blend composition of the background color and the drawing color by using the antialiasing process to compute a DST pixel value. The window combining device then updates the window number (step ST15). More specifically, the window combining device updates the window number in order to add the blend flag to the pixel value on which the blend composition is carried out. In the example shown in FIG. 3, the window combining device updates the window number to “3” in order to add the blend flag to the pixel on which the blend composition is carried out. Then, the window combining device advances the sequence to step ST16.

The window combining device, in step ST16, carries out writing of the DST pixel. More specifically, the window combining device draws the DST pixel value in the display window. Then, the window combining device advances the sequence to step ST17.

The window combining device, in step ST17, checks to see whether or not the process on every of all the pixels is completed. When, in this step ST17, determining that the process on every of all the pixels is not completed, the window combining device returns the sequence to step ST11 and repeats the above-mentioned process. In contrast, when, in this step ST17, determining that the process on every of all the pixels is completed, the window combining device ends the combining process of combining the window into the display window.

In this embodiment, the blend composition which is carried out in above-mentioned step ST14 can be expressed by, for example, the following equation (1).

Dr′=Sr×α+Dr×(1−α)

Dg′=Sg×α+Dg×(1−α)

Db′=Sb×α+Db×(1−α) (1)

where Dr: the R component of the DST pixel,

Dg: the G component of the DST pixel,

Db: the B component of the DST pixel,

Sr: the R component of the SRC pixel,

Sg: the R component of the SRC pixel,

Sb: the R component of the SRC pixel,

Dr′: the R component of the DST pixel (after the computation),

Dg′: the G component of the DST pixel (after the computation), and

Db′: the B component of the DST pixel (after the computation).

By carrying out the window combining process shown in the flow chart of above-mentioned FIG. 4, the window combining device can determine if each pixel of the display window uses a pixel value of which drawn window. In addition, the window combining device can determine the pixels, among the plurality of pixels of the display window, to each of which the blend is applied through the antialiasing process.

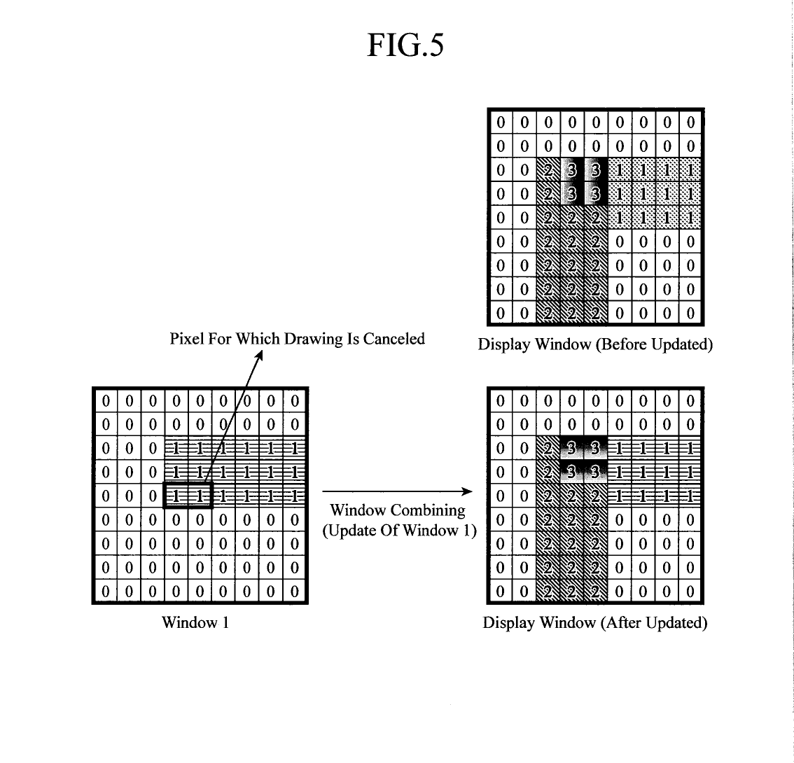

FIG. 5 is a diagram for explaining recombination of a window into a display window which is carried out by the window combining device 1, and shows an example in which a window 1 among a plurality of windows combined into the display window is updated.

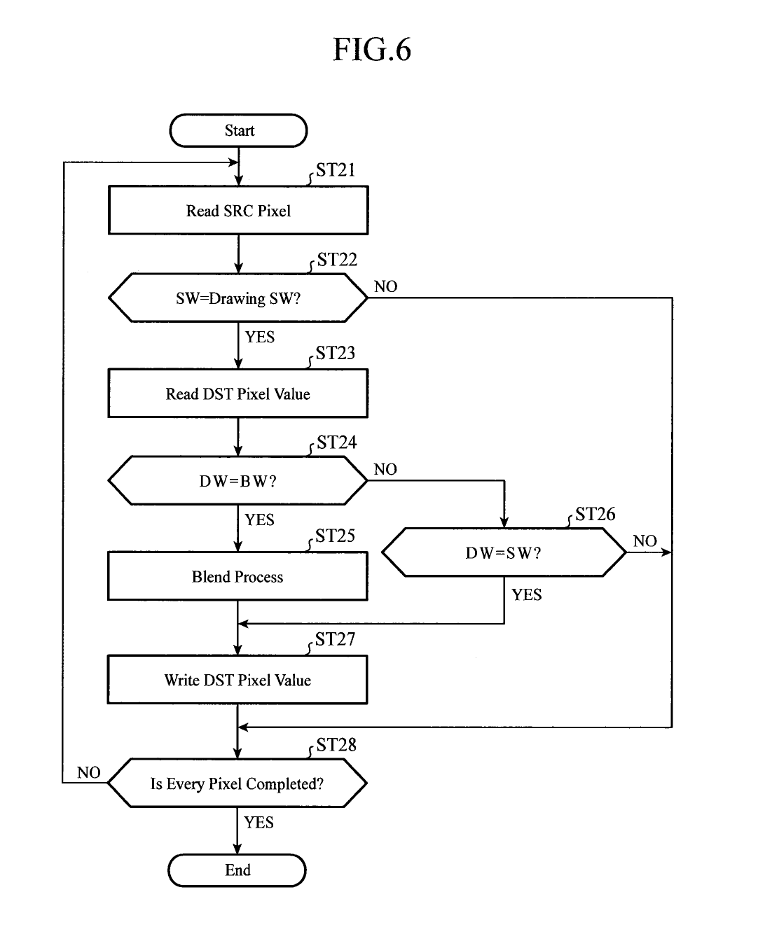

FIG. 6 is a flow chart showing the process of recombining a window into a display window which is carried out by the window combining device 1. In the process of recombining a window into a display window, reading of each SRC pixel is carried out first (step ST21). More specifically, the window combining device reads each SRC pixel which is a pixel of the window 1 from the VRAM (frame buffer) 10.

The window combining device then checked to see whether the window number (drawing SW) of the SRC pixel read in step ST11 matches the window number (SW) of the updated window (step ST22). When, in this step ST22, determining that the window number of the SRC pixel does not match that of the updated window, the window combining device advances the sequence to step ST28. Because the combination shown in the example shown in FIG. 5 is the one of the window 1 into the display window, “SW=1.” Therefore, when the window number of the SRC pixel is not “1,” the window combining device advances the sequence to step ST28.

In contrast, when, in step ST22, determining that the window number of the SRC pixel matches that of the updated window, the window combining device carries out reading of the DST pixel value (step ST23). More specifically, the window combining device reads the DST pixel value which is the pixel value of the display window.

The window combining device then checks to see whether the window number (DW) of the DST pixel matches a window number (BW) to which the blend flag is added, i.e., whether or not the blend flag is added to the DST pixel (step ST24). In the example shown in FIG. 5, a pixel to which the blend flag is added is the one whose window number is “3.”

When, in this step ST24, determining that the blend flag is added to the DST pixel, the window combining device then carries out the blend process (step ST25). More specifically, the window combining device carries out blend composition of the background color and the drawing color by using the antialiasing process to compute a DST pixel value. After that, the window combining device advances the sequence to step ST27.

In contrast, when, in step ST24, determining that the blend flag is not added to the DST pixel, the window combining device checks to see whether the window number (DW) of the DST pixel matches the window number (SW) of the drawn window (step ST26). In the example shown in FIG. 5, the window combining device checks to see whether or not the window number of the corresponding pixel of the display window is “1.”

When, in this step ST26, determining that the window number of the DST pixel does not match the window number of the drawn window, the window combining device cancels the drawing and then advances the sequence to step ST28. In contrast, when, in step ST26, determining that the window number of the DST pixel matches the window number of the drawn window, the window combining device determines the pixel value of the window 1 is the DST pixel value and then advances the sequence to step ST27.

The window combining device, in step ST27, carries out writing of the DST pixel value. More specifically, the window combining device draws the DST pixel in the display window. After that, the window combining device advances the sequence to step ST28.

The window combining device, in step ST28, checks to see whether or not the process on every of all the pixels is completed. When, in this step ST28, determining that the process on every of all the pixels is not completed, the window combining device returns the sequence to step ST21 and repeats the above-mentioned process. In contrast, when determining that the process on every of all the pixels is completed, the window combining device ends the recombining process of recombining the window into the display window.

By carrying out the above-mentioned process, the window combining device can apply the antialiasing process to the combining of windows.

In this embodiment, the blend process for recombination which is carried out in above-mentioned step ST25 can be expressed by, for example, the following equation (2). This equation (2) is a combination of an equation for computing an original background color through an inverse blend computation, and an equation for creating a drawing color through a blend.

Dr′=Dr+(Sr′−Sr)×α

Dg′=Dg+(Sg′−Sg)×α

Db′=Db+(Sb′−Sb)×α (2)

where Dr: the R component of the DST pixel,

Dg: the G component of the DST pixel,

Db: the B component of the DST pixel,

Sr: the R component of the SRC pixel (yet-to-be-updated window),

Sg: the G component of the SRC pixel (yet-to-be-updated window),

Sb: the B component of the SRC pixel (yet-to-be-updated window),

Dr′: the R component of the DST pixel (after computation),

Dg′: the G component of the DST pixel (after computation),

Db′: the B component of the DST pixel (after computation),

Sr′: the R component of the SRC pixel (updated window),

Sg′: the G component of the SRC pixel (updated window), and

Sb′: the B component of the SRC pixel (updated window).

As mentioned above, the window combining device can compute a correct drawing color by computing a background color for a pixel which is included in the outline of an object in an updated window and which overlaps another window through an inverse blend computation, and carrying out a blend of the background color and the object color anew.

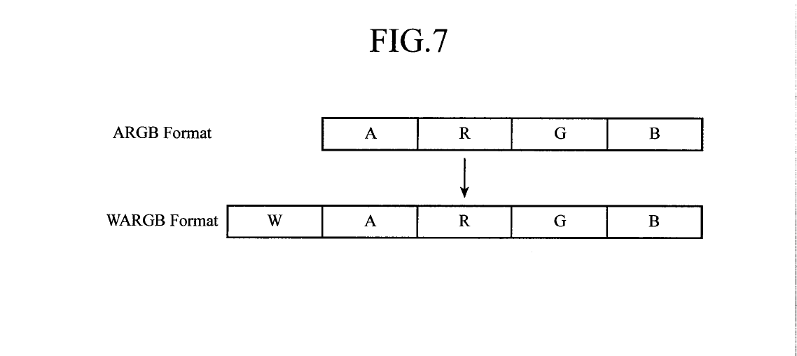

FIG. 7 is a diagram for explaining the configuration of a pixel value for use in the window combining device 1. A typical pixel format used these days is an ARGB format. A denotes an a value, and R, G, and B denote color values and show red, blue, and green color components, respectively. By applying a WARGB format to pixel values, the window combining device facilitates the generation of an address to the frame buffer at the time of the combining of windows.

When pixel values are set to have the ARGB format, the window combining device needs to generate an address at which a window number (W) is stored in addition to the generation of addresses for the α value and the color values (ARGB). A problem with a conventional window combining device is that because the conventional window combining device includes a color buffer and a stencil buffer as separate buffers, for example, the address decoding becomes complicated and, as a result, the combining process of combining windows becomes difficult. In contrast with this, the configuration in accordance with Embodiment 1 of the present invention makes it possible to carry out the address generation only once by applying the WARGB format to pixel values, thereby being able to facilitate the combining process of combining windows.

Nowadays, most of SDRAM-SDRMs, DDR2-SDRMs, DDR3-SDRAMs and so on, which are used as VRAMs, have a data width of 16 bits or 32 bits. Therefore, by setting the data width of each pixel to 32 bits, and assigning 32 bits to each component of the WARGB format, the address generation is further simplified. For example, the 32 bits is divided among the components of the WARGB format in such a way that W=4 bits, A=4 bits, R=8 bits, G=8 bits, and B=8 bits. The method of dividing the 32 bits among the components is not limited to this example but can be an arbitrary one.

While the invention has been described in its preferred embodiment, it is to be understood that various changes can be made in an arbitrary component in accordance with the embodiment, and an arbitrary component in accordance with the embodiment can be omitted within the scope of the invention.

### INDUSTRIAL APPLICABILITY

The window combining device in accordance with the present invention is suitable for use in a device that carries out generation of a display screen which consists of a plurality of windows in a personal computer, and that generates a display of images overlaid one another, or for generation or the like of a display screen in an embedded device.

### EXPANATIONS OF REFERENCE NUMERALS

1 window combining device, 2 CPU, 3 CPU control unit, 4 two-dimensional drawing engine, 5 vector engine, 6 pixel computing unit, 7 window control unit, 8 VRAM control unit, 9 display control unit, 10 VRAM, and 11 display device.

1. A window combining device comprising:
a window control unit for adding one window number to pixels on a window-by-window basis;
a two-dimensional drawing engine for combining a drawn window including the pixels to which the window number is added by said window control unit into a display window, and for adding a blend flag to a pixel which is a target for an antialiasing process, the blend flag showing that the pixel is the target for the antialiasing process, and computing an original background color from the pixel in said display window to which said blend flag is added and carrying out said antialiasing process; and
a display control unit for displaying the display window into which the drawn window is combined by said two-dimensional drawing engine.

2. The window combining device according to claim 1, wherein when combining the drawn window into the display window, the two-dimensional drawing engine combines only the pixels in the drawn window to which the window number is added into the display window.

3. The window combining device according to claim 2, wherein said window combining device includes a frame buffer in which pixels forming a window are stored as pixel values, and each of the pixel values stored in said frame buffer is comprised of color values, an a value, and a window number and is specified by one address.

4. (canceled)

5. The window combining device according to claim 1, wherein when an update occurs in one of a plurality of drawn windows which construct the display window, the two-dimensional drawing engine recombines only pixels appearing on a display surface, among pixels of the window for which the update occurs, into the display window.

6. The window combining device according to claim 5, wherein the two-dimensional drawing engine carries out the antialiasing process when performing the recombining.
